(19) United States
(12) Patent Application Publication
(10) Pub. No.: US 2012/0134490 A1
(43) Pub. Date: May 31, 2012

(54) Selective Data Encryption and Decryption Method and Apparatus

(75) Inventor: Hui LIU, Beijing (CN)

(73) Assignee: Beijing Z & W Technology Consulting Co., Ltd., Bejing (CN)

(21) Appl. No.: 12/976,931

(22) Filed: Dec. 22, 2010

(30) Foreign Application Priority Data
Nov. 29, 2010 (CN) 201010566287.6

(51) Int. Cl. H04L 9/28

(52) U.S. Cl. 380/28

(57) ABSTRACT

This present application relates to the field of data encryption and decryption technology, and in particular, relates to a selective data encryption and decryption method and apparatus. The encryption method includes: generating a string of true random numbers 0, 1 of a predetermined length via the preset method as a random seed; acquiring data for several times from the random seed, and cascading the data acquired each time into a random string no shorter than the length of a plaintext; according to the random string, generating a plaintext encryption bit identifier random string; randomly selecting more than one half of plaintext data for encryption according to the plaintext encryption bit identifier random string; arranging the encrypted data and unencrypted data to form a ciphertext according to their positions of the plaintext. The encryption apparatus includes: true random number generation module, encryption bit identifier random string generation module, plaintext selectivity encryption module and ciphertext formation module. This application also provides a selective data decryption method and apparatus. This invention reduces the amount of data to be encrypted or decrypted, thus improves the data encryption and decryption performance.

### BACKGROUND OF THE INVENTION

1. Field of Invention

This invention relates to data encryption and decryption technology field, and in particular, relates to a selective data encryption and decryption method and apparatus.

2. Description of the Related Art

The encryption of data has proven to be an effective method of data protection. The traditional method of data encryption is to encrypt all data once or more by an encryption algorithm; because data encryption and decryption process requires a lot of system resources and time, it is very difficult to protect data and meanwhile to realize good data access performance.

### SUMMARY OF THE INVENTION

In order to solve the problems that the existing encryption technologies in the encryption and decryption process consume much system resources and time, and that the data access performance is poor, this invention proposes a selective data encryption and decryption method and apparatus and realizes that, the amount of data encrypted or decrypted is reduced when a same degree of protection with all the original data encrypted is obtained, thus improving data encryption and decryption performance.

This invention provides a selective data encryption method, and the method comprises:

generating a string of true random number 0, 1 of a predetermined length by a preset method as a random seed;

acquiring data for several times from the random seed, and cascading the data acquired each time into a random string no shorter than the length of a plaintext;

according to the random string, generating a plaintext encryption bit identifier random string;

according to the plaintext encryption bit identifier random string, selecting more than one half of plaintext data for encryption; and

according to the position of the plaintext, arranging the encrypted data and =encrypted data to form a ciphertext.

This invention provides a selective data encryption apparatus, and the apparatus includes:

a true random number generation module for generating and storing by the preset method true random numbers and a string of true random numbers 0, 1 of a predetermined length as a random seed;

an encryption bit identifier random string generation module for acquiring data for several times from random seed generated by the true random number generation module, cascading the data acquired each time into a random string no shorter than the length of a plaintext, and according to the random string, generating a plaintext encryption bit identifier random string;

a plaintext data selectivity encryption module for randomly selecting more than one half of the plaintext data for encryption according to the plaintext encryption bit identifier random string generated by the encryption bit identifier random string generation module; and

a ciphertext formation module for arranging the data encrypted by the plaintext data selectivity encryption module and the unencrypted data according to their positions in the plaintext to form a ciphertext.

This invention provides a selective data decryption method, and the method comprises:

acquiring data from a random seed, and regenerating a plaintext encryption bit identifier random string corresponding to the encrypted plaintext;

extracting the encrypted data from the ciphertext and decrypting the encrypted data according to the plaintext encryption bit identifier random string; and

arranging the decrypted data and unencrypted data according to their positions in the ciphertext to form a plaintext.

This invention also provides a selective data decryption apparatus, and the apparatus includes:

an encryption bit identifier random string restructuring module for acquiring data from the random seed, and to regenerate a plaintext encryption bit identifier random string corresponding to the encrypted plaintext;

an encrypted data extraction and decryption module for extracting the encrypted data from ciphertext according to the plaintext encryption bit identifier random string and to decrypt;

a plaintext restoration module for arranging the decrypted data and unencrypted data according to their positions in the ciphertext to form a plaintext.

In this invention, more than one half of data in the plaintext are randomly selected for encryption according to the plaintext encryption bit identifier random string formed by acquiring data from the generated random seed for several times; at the time of decryption, through the regenerated plaintext encryption bit identifier random string corresponding to the encrypted plaintext, the encrypted data in the ciphertext are selected for decryption, thus improving the speed of data encryption and decryption greatly without sacrifice in the degree of data protection.

### BRIEF DESCRIPTION OF THE DRAWINGS

FIG. 1 shows a flow chart of the selective data encryption method provided in the embodiment of this invention;

FIG. 2 shows a flow chart of the method for the generation of a plaintext encryption bit identifier random string provided in the embodiment of this invention;

FIG. 3 shows a flow chart of the method for the determination of whether a duplicate plaintext encryption bit identifier random string is generated provided in the embodiment of this invention;

FIG. 4 shows a schematic diagram for the generation method of a plaintext encryption bit identifier random string provided in the embodiment of this invention;

FIG. 5 shows a structure diagram for the selective data encryption apparatus provided in the embodiment of this invention;

FIG. 6 shows a flow chart of the selective data decryption method provided in the embodiment of this invention;

FIG. 7 shows a structure diagram for the selective data decryption apparatus provided in the embodiment of this invention;

FIG. 8 shows a schematic diagram for the selective data encryption and decryption process provided in the embodiment of this invention.

### DETAILED DESCRIPTION OF THE PRESENTLY PREFERRED EMBODIMENTS

The following preferred embodiments are provided for further illustrating, but not for limiting, the present invention.

In the embodiment of this invention, more than one half of data in the plaintext are randomly selected for encryption, according to plaintext encryption bit identifier random string generated by acquiring data from the generated random seed for several times; at the time of decryption, through the regenerated plaintext encryption bit identifier random string corresponding to the encrypted plaintext, the encrypted data in the ciphertext are selected for decryption.

The embodiment of this invention is implemented by a selective data encryption method, and the method comprises:

generating a string of true random number 0, 1 of a predetermined length by a preset method as a random seed;

acquiring data for several times from the random seed, and cascading the data acquired each time into a random string no shorter than the length of a plaintext;

according to the random string, generating a plaintext encryption bit identifier random string;

according to the plaintext encryption bit identifier random string, selecting more than one half of plaintext data for encryption; and

according to the position of the plaintext, arranging the encrypted data and unencrypted data to form a ciphertext.

The purpose of this invention is to provide a selective data encryption apparatus, and the apparatus includes:

a true random number generation module for generating and storing by the preset method true random numbers and a string of true random numbers 0, 1 of a predetermined length as a random seed;

an encryption bit identifier random string generation module for acquiring data for several times from random seed generated by the true random number generation module, cascading the data acquired each time into a random string no shorter than the length of a plaintext, and according to the random string, generating a plaintext encryption bit identifier random string;

a plaintext data selectivity encryption module for randomly selecting more than one half of the plaintext data for encryption according to the plaintext encryption bit identifier random string generated by the encryption bit identifier random string generation module;

a ciphertext formation module for arranging the data encrypted by the plaintext data selectivity encryption module and the unencrypted data according to their positions in the plaintext to form a ciphertext.

This invention also aims to provide a selective data decryption method, and the method comprises:

acquiring data from the random seed, and regenerating a plaintext encryption bit identifier random string corresponding to the encrypted plaintext;

extracting the encrypted data from the ciphertext and decrypting them according to the plaintext encryption bit identifier random string; and

arranging the decrypted data and unencrypted data according to their positions in the ciphertext to form a plaintext.

This invention also aims to provide a data selectivity decryption apparatus, and the apparatus includes:

an encryption bit identifier random string restructuring module for acquiring data from the random seed, and regenerating a plaintext encryption bit identifier random string corresponding to the encrypted plaintext;

an encrypted data extraction and decryption module for extracting the encrypted data from ciphertext according to the plaintext encryption bit identifier random string and to decrypt;

a plaintext restoration module for arranging the decrypted data and unencrypted data according to their positions in the ciphertext to form a plaintext.

In combination with the following attached drawings and the embodiment of this invention, this invention is further described below.

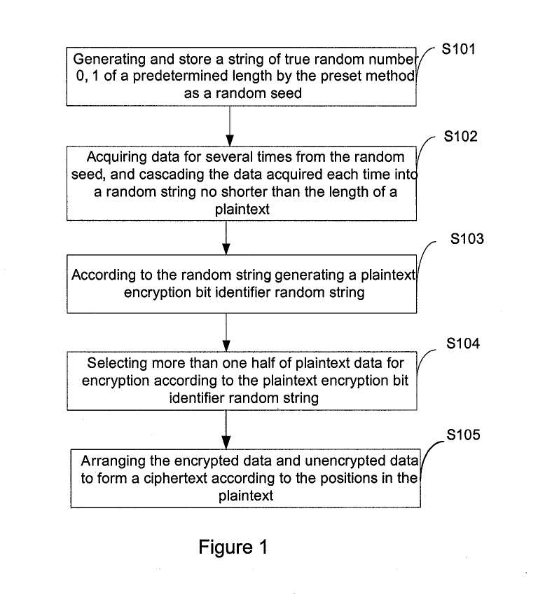

As shown in FIG. 1, the embodiment of this invention provides a selective data encryption method, including the following steps:

Step S101: generating and store a string of true random number 0, 1 of a predetermined length by the preset method as a random seed;

The generation method of true random number has been very mature, and in the specific implementation, the methods for the generation of random number given in Page 301, Applied Cryptography issued by Mechanical Industry Press on Mar. 1, 2003 can be used, such as by use of random noise, computer clock, CPU load or the number of network packets and other methods;

In the embodiment of this invention, after a string of true random number 0, 1 of a predetermined length is generated according to the preset method, it will be stored as a random seed, and it will be used when different plaintexts are encrypted or used for data acquisition at the time of decryption;

Step S102: acquiring data for several times from the random seed, and cascading the data acquired each time into a random string no shorter than the length of a plaintext;

Preferably, the starting position of each time data acquired from the random seed and the acquisition length are random;

To further enhance the randomness, in the embodiment of this invention, after the step that the data acquired each time is cascaded into the random string of the length greater than the length of the plaintext, data are also acquired from the 0, 1 random string for several times to generate a new 0, 1 random string with the length no shorter than the length of the plaintext, and then the new random string is used to generate a plaintext encryption bit identifier random string;

Preferably, the starting position of each time data acquired from the random string is random;

Step S103: according to the random string, generating a plaintext encryption bit identifier random string;

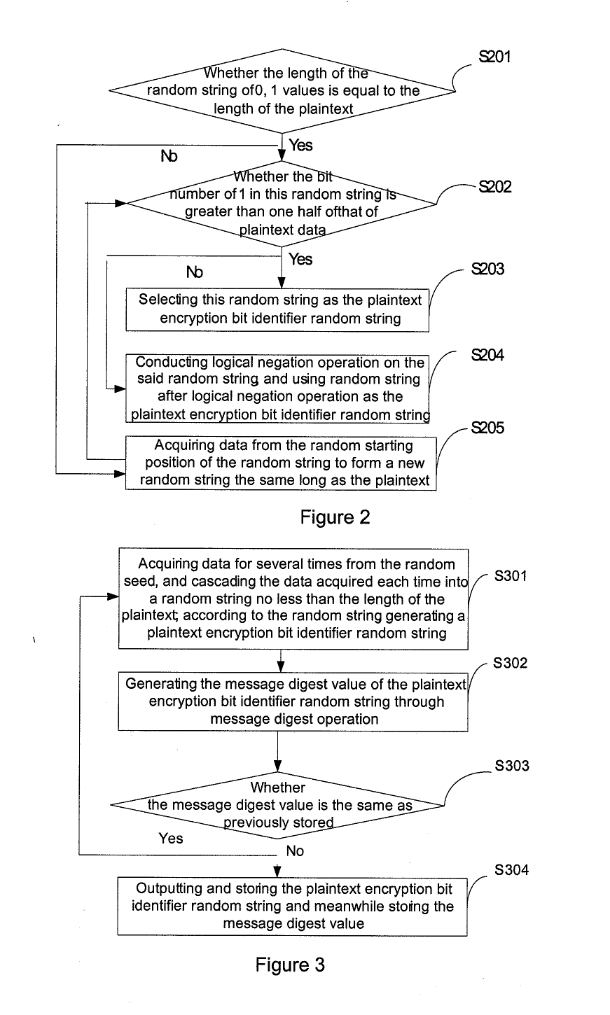

As shown in FIG. 2, this invention provides a method for generating a plaintext encryption bit identifier random string according to the random string, and the steps are described below:

Step S201: determining whether the length of the random string of 0, 1 values is equal to the length of the plaintext; if so, perform Step S202, and if not, perform Step S205;

Step S202: determining whether the number of 1 in this random string is greater than one half of the bit number of plaintext data; if so, perform Step S203 and If not, perform Step S204;

Step S203: selecting this random string as the plaintext encryption bit identifier random string;

Step S204: conducting logical negation operation on the random string, and using random string after logical negation operation as the plaintext encryption bit identifier random string;

Step S205: acquiring data from the random starting position of the random string to form a new random string of the same length as the plaintext, and then to perform Step S202.

In Step S205, if the data are acquired to the tail of a random string, returning to the head to continue acquiring until a new data string of the same length as the plaintext is acquired;

Till here, the plaintext encryption bit identifier random string used for selective data encryption, is generated;

Step S104: selecting more than one half of plaintext data for encryption according to the plaintext encryption bit identifier random string;

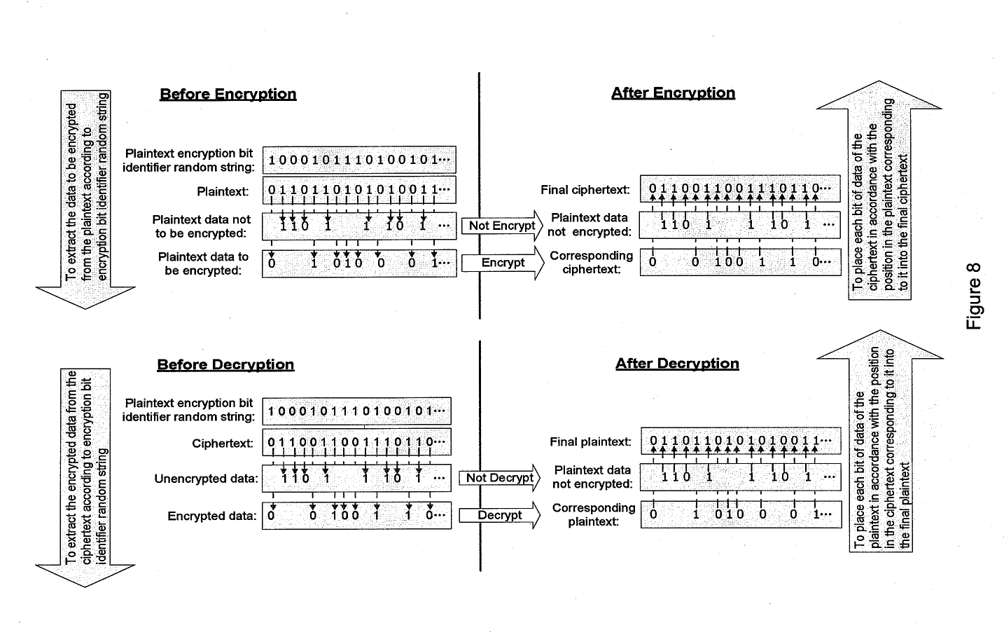

As shown in FIG. 8, this invention provides a schematic diagram for which the plaintext data are encrypted by use of the plaintext encryption bit identifier random string. In the embodiment of this invention, after a plaintext encryption bit identifier random string is generated, from the first bit of data, arranging the plaintext encryption bit identifier random string and the plaintext data correspondingly bit by bit in parallel, selecting the plaintext data corresponding to 1 in the plaintext encryption bit identifier random string as the encrypted data, and then using the specified encryption function and its corresponding encryption key to encrypt them, that is, to complete the encryption of the selected data;

Step S105: arranging the encrypted data and unencrypted data to form a ciphertext according to the positions in the plaintext.

Security feasibility analysis on selecting more than one half of plaintext data for encryption, is illustrated as follows,

Assuming the amount of data of the plaintext to be encrypted is m bits (m is natural number), for the binary system, each bit of data is 0 or 1. For the determined encryption algorithm, under the circumstance that encryption key is unknown (usually, the encryption function can be learned), the complexity of time illegally cracked is usually polynomial time on the function of key length, that is O(f(l)), wherein l is the length of the encryption key and f(l) is the function about l.

Typically, the degree of data protection for original amount of encrypted data can be measured by the time complexity to break ciphertext illegally, that is, in the case of equal l, the greater f(l) is, the greater O(f(l)) is, the more time and resources required to illegally break ciphertext, or say, that the ciphertext is more secure.

Because ciphertext data can be decrypted bit by bit, the time complexity to break the ciphertext can be expressed as O′(f(l)), where O′(f(l)) is time complexity for each bit of the ciphertext to be cracked. Clearly, O(f(l))=m×O′(f(l)).

On the other hand, if n bits are randomly selected from the plaintext for encryption (n is natural number), because all of the plaintext bits to be encrypted are equiprobable (they may be 0 or 1), using the same encryption algorithm, the time complexity to illegally crack ciphertext can be expressed as Cₘⁿ×O′(f(l)).

In order not to affect the effect of data protection, the following needs to be enabled

Cₘⁿ×O′(f(l))≧m×O′(f(l))

That is, Cₘⁿ≧m, by calculating, when

$$n \geq \frac{m}{2}$$

### (When

$$\frac{m}{2}$$

is an integer) or

$$n \geq [ \frac{m}{2} ] + 1$$

(when

$$\frac{m}{2}$$

is not an integer), Cₘⁿ≧m, so that Cₘⁿ×O′(f(l))≧m×O′(f(l)).

In other words, when the following conditions are met, the amount of encrypted data can be reduced without sacrifice in the effect of data protection.

1) The plaintext data are randomly selected for encryption or no encryption, the probability of each plaintext data to be encrypted is equal, and the encryption position of plaintext data is irregular and (in the other plaintext) is not duplicate, so that, cryptanalysts can not obtain the position of the same plaintext data to be encrypted from different ciphertexts;

2) The amount of encrypted data is no less than one half of that of plaintext data.

As shown in FIG. 3, in the embodiment Of this invention, after the step that a plaintext encryption bit identifier random string is generated according to the random string, also determining whether the plaintext encryption bit identifier random string has been already generated; if so, re-generating a new plaintext encryption bit identifier random string; otherwise, outputting and storing the plaintext encryption bit identifier random string, and the specific realization steps are as follows:

Step S301: acquiring data for several times from the random seed, and cascading the data acquired each time into a random string no shorter than the length of the plaintext; according to the random string, randomly generating a plaintext encryption bit identifier random string.

Step S302: generating the message digest value of the plaintext encryption bit identifier random string through message digest operation;

The message digest of the plaintext encryption bit identifier random string can be calculated by use of MD5 or SHA1 algorithms;

Step S303: determining whether the message digest value is the same as the message digest value of the previously stored plaintext encryption bit identifier random strings; if so, perform Step S301; otherwise perform Step S304;

Step S304: outputting and storing the plaintext encryption bit identifier random string, and meanwhile storing the message digest value.

Two implementation methods for this invention are provided below, but the scope of protection of this invention is not limited to these two implementation methods.

### Method 1: Fixed-Bit Constant-Length Plaintext Encryption Method

Assuming there are several plaintexts to be encrypted, select the plaintext k, and the plaintext has m bits, and n bits need to be selected for encryption, of which m, n and k are natural number and

$$n \geq [ \frac{m}{2} ] + 1 , [ \frac{m}{2} ]$$

is the rounding operation on

$$\frac{m}{2} .$$

The main steps for the method of selecting randomly data from the plaintext k for encryption are as follows:

1. Generating and storing a string of random number 0, 1 of the predetermined length w bits as a random seed, of which w is natural number, and w>m;

2. Acquiring data randomly from the random seed for the predetermined times u (u is natural number), and the starting position of each time acquired data and the length of acquired data (can be greater than or equal to 0) are random; if the data are acquired to the tail of the random seed, return to the head to continue data acquisition;

Before each data acquisition, two random numbers are first generated, and they are modulo operated respectively to obtain a random starting cursor position and the length of the data required to be acquired;

In details, prior to the data acquisition, generating two random numbers R1, R2 at first, and then generating two random values T1, T2 respectively less than w and p−q (in which, q is a natural number less than or equal to q, w is the length of the random seed, p is the length of the plaintext encryption bit identifier random string required to be generated, q is the length of the data already generated, and p−q is the number of bits of the remaining data not acquired in the random string), then

T1=R1 mod w

T2=R2 mod (p−q)

Where, mod is modulo operation.

3. Cascading the data acquired each time into a p-bit random string of 0, 1 values (p is natural number, and p=m in this method);

4. Counting the number n of 1 in the random string, and in case of

$$n \geq [ \frac{m}{2} ] + 1 ,$$

selecting the random string as the plaintext encryption bit identifier random string.

In case of

$$n < [ \frac{m}{2} ] + 1 ,$$

conducting logical negation operation on the whole random string, and then

$$n \geq [ \frac{m}{2} ] + 1 ,$$

using random string after logical negation operation as the plaintext encryption bit identifier random string;

5. Outputting m-bit plaintext encryption bit identifier random string, starting from the first bit of data, arranging this plaintext encryption bit identifier random string and plaintext data correspondingly bit by bit in parallel, and encrypting the plaintext data corresponding to 1 in the plaintext encryption bit identifier random string.

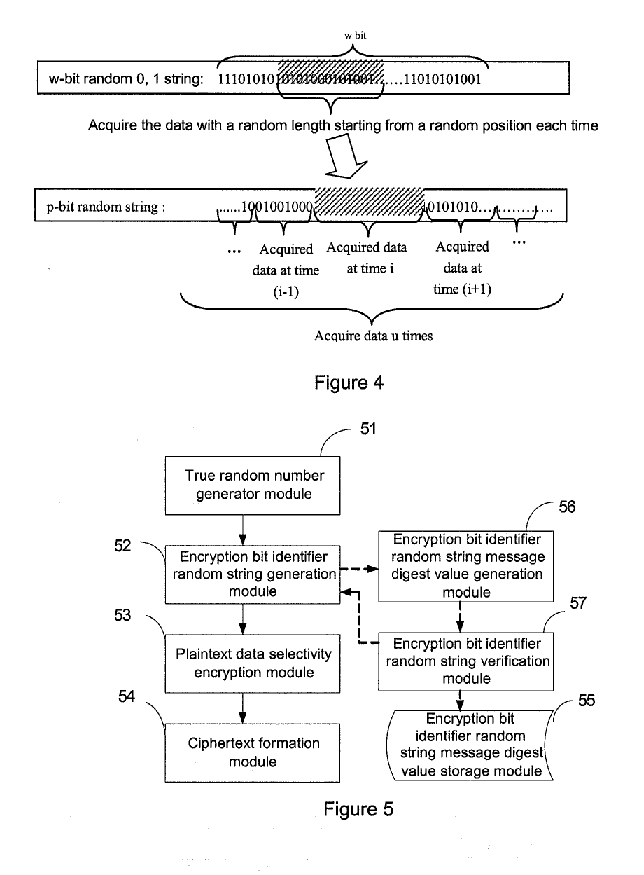

As shown in FIG. 4, the embodiment of this invention provides the schematic diagram for the generation method of plaintext encryption bit identifier random string.

In this diagram, if identifying the m-bit plaintext encryption bit identifier random string corresponding to the plaintext k as reₖ, then reₖ is equal to the sequence combination or logical negation result (if

$$n < [ \frac{m}{2} ] + 1 )$$

of the data randomly acquired for u times from the random seed of the specified length; identifying the data acquired from the random seed at the time i as (Curₛ, Curₑ)ᵢ, where, i is a natural number, and i≦u, and Curₛ is the starting cursor position for the data acquired at the time i from the random seed; accordingly, Curₑ is the ending cursor position for the data acquired at the time i. Curₛ and Curₑ are offset identifiers from the first bit of the random seed; clearly both Curₛ and Curₑ are integer numbers greater than or equal to 0, and less than or equal to m, and Curₑ is greater than or equal to Curₛ, When Curₑ is equal to Curₛ, the bits of data acquired at the determined time is 0. Thus, the data acquired at the time i is bits of data between Curₛ and Curₑ in the random seed. Further, the plaintext encryption bit identifier random string reₖ can be expressed as:

reₖ=[(Curₛ,Curₑ)₁,(Curₛ,Curₑ)₂, . . . (Curₛ,Curₑ)ᵢ . . . (Curₛ,Curₑ)ᵤ]ₖ

$$( When n \geq [ \frac{m}{2} ] + 1 )$$

Or

reₖ=˜[(Curₛ,Curₑ)₁,(Curₛ,Curₑ)₂, . . . (Curₛ,Curₑ)ᵢ, . . . (Curₛ,Curₑ)ᵤ]ₖ

$$( When n < [ \frac{m}{2} ] + 1 )$$

In the following, the true randomness or non-reproducibility of the plaintext encryption bit identifier random string is analyzed:

It is critical for the entire system not to be easily cracked by cryptanalysts to ensure the true randomness and non-reuse of the plaintext encryption bit identifier random string.

It should be noted that as long as the character used as a plaintext encryption bit identifier random string is limited, the key may be reproduced, and its randomness is reflected in very small probability of reproducibility and irregular reproducibility.

For example, assuming that the plaintext encryption bit identifier random string has 1024 bits, because only 0 and 1 can form the random string, no matter how they are random, the probability of their reproducibility is still greater than 1/2¹⁰²⁴, or 1/(1.79*10³⁰⁸.)

Further, the probability of repeated plaintext encryption bit identifier random strings in the implementation can be calculated. For the same random seed, because there can be w kinds of data acquisition possibilities every time (random seed is w-bit), in this implementation, after data are acquired for u times, the probability of reproducibility of random string of encrypted bit identifiers of the p-bit plaintext is 1/w^{u}.

If the specified encryption algorithm (function) is used to encrypt 10M bytes plaintext, the size of the used random seed is 1 Gbit, i.e. w=1,000,000,000, and data are acquired for 1000 times, that is, u=1000, the probability of the repeated plaintext encryption bit identifier random strings produced through the implementation method is 1/10⁹⁰⁰⁰, so the probability of repeatability is low enough, in line with the characteristics of random features.

In actual use, users can continue to improve its randomness by increasing the u and w to reduce the probability of its repetition, or by periodic replacement of the random seed, to ensure a more secure plaintext encryption bit identifier random string.

### Method 2: Variable-Bit Variable-Length Plaintext Encryption Method

Similar to Method 1, the difference is that p in the implementation is of uncertain length, starting to traverse and generate a plaintext encryption bit identifier random string from the random position of p-bit random string. By the uncertainty of the starting traversal position, the security of the entire system is enhanced.

The specific implementation steps are as follows (the data are set similar to the method 1):

1. Generating and storing a random number 0, 1 string of the predetermined length w bits as a random seed, of which w is natural number, and w>m;

2. Acquiring random data from the random seed for the determined times u (u is natural number), and the starting position of data acquired every time and the length of the data acquired (which can be greater than or equal to 0) are random; if the data has been acquired to the tail of the random seed, return to the head to continue data acquisition;

Before each data acquisition, generate two true random numbers at first, and then conduct modulo operations on the two random numbers respectively to obtain the starting cursor position needed for the random data acquisition and the length of the data required for being acquired. The method for the random data acquisition of the random seed is the same as Method 1;

3. Cascading the data acquired every time into a specified p-bit random string (p is natural number, p>m);

4. Acquiring m-bit data from a random starting position in the p-bit random string, and when the data is acquired to the tail of the random string, need to return the head to continue acquiring until enough bits are acquired, and outputting a new random string; it is need to note that, the random starting position needs to be determined by modulo the random number generated.

In details, generating a true random number R3 before data acquisition, and then generating a random value T3 less than p, that is,

T3=R3 mod p

Where, mod is modulo operation.

5. Counting and determining the number n of 1 in the random string, and in case of

$$n \geq [ \frac{m}{2} ] + 1 ,$$

selecting the random string as the plaintext encryption bit identifier random string.

In case of

$$n < [ \frac{m}{2} ] + 1 ,$$

conducting logical negation operation on the whole random string, so that

$$n \geq [ \frac{m}{2} ] + 1 ,$$

using random string after logical negation operation as the plaintext encryption bit identifier random string;

6. Outputting m-bit plaintext encryption bit identifier random string, corresponding them to the plaintext data bit by bit starting from the first data in order, and encrypting the plaintext data corresponding to 1 in the plaintext encryption bit identifier random string.

The true randomness or non-reproducibility of the plaintext encryption bit identifier random string with this method is analyzed in the following.

Compared with the method 1, a step is added into the method 2, that is, m-bit data are acquired from p-bit random string; because there are p kinds of possibilities for data acquisition, the probability of repetition of the plaintext encryption bit identifier random string in the method 2 is p*1/(p*w^{u}).

Further, taking the data set in the method 1 as an example, where p>m, i.e. p>80,000,000 (or 80M-bit), the minimum probability of the repeated plaintext encryption bit identifier random string generated through the method is 1/(8*10⁹⁰⁰⁷), and it shows the probability of repetition is low enough, in line with the characteristic of random features.

In actual use, to continue to improve its randomness by increasing p, u and w (reduce the probability of its repetition), or replacing periodically the random seed to ensure a more secure plaintext encryption bit identifier random string

In short, through the implementations above, it can be proved that it is feasible to enable selective data encryption in the practical application.

In this invention, in the selective encryption process of data, need to record and store the generated random seed, the corresponding information reₖ to re-generate the plaintext encryption bit identifier random string corresponding to the plaintext k encrypted from the random seed, and information whether to use logic negation operation or not when a plaintext encryption bit identifier random string is generated, and the starting cursor position information of data acquisition to traverse when the data of p-bit random string are acquired to generate a plaintext encryption bit identifier random string, for decrypting the data.

As shown in FIG. 5, this invention provides a selective data encryption apparatus, and the apparatus includes:

True random number generator module 51, encryption bit identifier random string generation module 52, plaintext data selectivity encryption module 53 and ciphertext formation module 54;

During encryption, true random number generation module 51 according to the preset method first generates and stores random numbers and a string of true random number 0, 1 of a predetermined length as a random seed; encryption bit identifier random string generation module 52 acquires data for several times from the random seed generated by the true random number generation module 51, cascades the data acquired each time into a random string no shorter than the length of the plaintext; and generates a plaintext encryption bit identifier random string according to the random string; plaintext data selectivity encryption module 53, depending on the plaintext encryption bit identifier random string generated by the encryption bit identifier random string generation module 52 selects more than one half of the plaintext data for encryption; ciphertext formation module 54 arranges the data encrypted by the plaintext data selectivity encryption module 53 and the unencrypted data according to their positions in the plaintext to form a ciphertext.

As shown in FIG. 5, the selective data encryption apparatus provided by this invention includes:

encryption bit identifier random string message digest value storage module 55, for storing the encryption bit identifier random string message digest value;

encryption bit identifier random string message digest value generation module 56, for generating through message digest operation the message digest value of the plaintext encryption bit identifier random string generated by the encryption bit identifier random string generation module 52, and returning this message digest value to the encryption bit identifier random string message digest value storage module 55;

encryption bit identifier random string verification module 57, for comparing the encryption bit identifier random string message digest value generated by the encryption bit identifier random string message digest value generation module 56 and the message digest value in the encryption bit identifier random string message digest value storage module 55, and outputting the comparison result to the encryption bit identifier random string generation module 52.

encryption bit identifier random string generation module 52, according to the comparison result that they are same, fed back by the encryption bit identifier random string verification module 57, for re-generating a new plaintext encryption bit identifier random string, and repeating the verification steps of message digest value above, until generating a different plaintext encryption bit identifier random string; if comparison result that they are different is fed back, the plaintext encryption bit identifier random string is output and the message digest value of the plaintext encryption bit identifier random string is stored into the encryption bit identifier random string message digest value storage module 55.

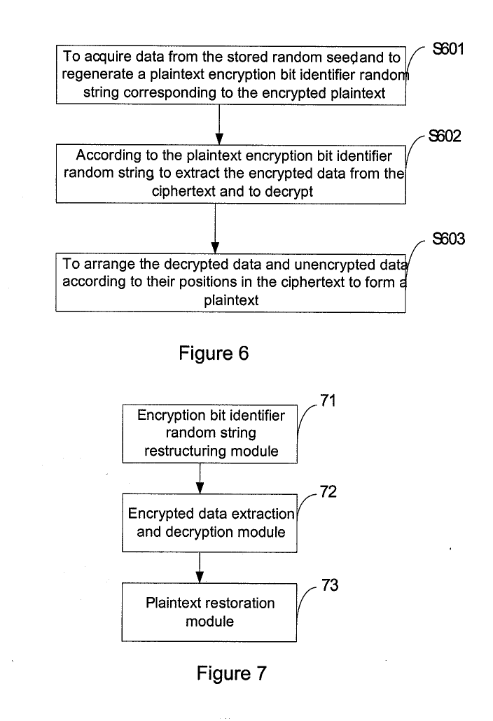

As shown in FIG. 6, the embodiment of this invention provides a selective data decryption method, and the method comprises the following steps:

Step S601: acquiring data from the stored random seed, and regenerating a plaintext encryption bit identifier random string corresponding to the encrypted plaintext;

In the embodiment of this invention, at the time of decryption, according to the information recorded and saved when data are encrypted, such as corresponding information reₖ of the plaintext encryption bit identifier random string corresponding to the encrypted plaintext (ciphertext), whether to conduct logical negation operation, the starting traversal cursor position of data acquisition when p-bit random string greater than the length of the plaintext is acquired to generate a data string equal to the length of the plaintext, acquire data for several times from the saved random seed at the time of encryption to regenerate the plaintext encryption bit identifier random string corresponding to the encrypted plaintext;

Step S602: extracting the encrypted data from the ciphertext and to decrypt according to the plaintext encryption bit identifier random string;

In the embodiment of this invention, decryption function and decryption key used at time of decryption are uniquely corresponding to encryption function and encryption key used at the time of encryption;

As shown in FIG. 8, the embodiment of this invention provides the schematic diagram for the data decryption process by use of the data string of encrypted bits of the plaintext;

Step S603: arranging the decrypted, data and unencrypted data according to their positions in the ciphertext to form a plaintext.

As shown in FIG. 7, the embodiment of this invention also provides a selective data decryption apparatus, and the apparatus includes:

Encryption bit identifier random string restructuring module 71, encrypted data extraction and decryption module 72 and plaintext restoration module 73;

At time of data decryption, the encryption bit identifier random string restructuring module 71 acquires again data from the stored random seed, and restructures and generates a plaintext encryption bit identifier random string corresponding to the encrypted plaintext; the encrypted data extraction and decryption module 72 according to the plaintext encryption bit identifier random string restructured by the encryption bit identifier random string restructuring module 71 extracts the encrypted data from the ciphertext and decrypts; the plaintext restoration module 73 arranges the data extracted and decrypted by the encrypted data extraction and decryption module 72 and the unencrypted data according to their positions in the ciphertext to form a plaintext.

In the embodiment of this invention, through the use of the generated random seed, randomly acquiring data for several times to generate a plaintext encryption bit identifier random string, and using the plaintext encryption bit identifier random string to randomly select from the plaintext more than one half of the data for encryption, thus without sacrifice in data protection strength, reducing the amount of data to be encrypted, and greatly improving the speed of data encryption; in the process of decryption, regenerating the plaintext encryption bit identifier random string corresponding to the encrypted plaintext, and using the random string to extract and decrypt the encrypted data in the ciphertext, thus reducing the amount of data to be decrypted, and greatly improving the speed of data encryption.

All above is just the preferred embodiment of this invention, but is not used to limit this invention; any changes, equivalent replacements and improvements and other aspects made within the spirit and principle of this invention should be included in the protective range of this invention.

I claim:

1. A selective data encryption method comprising:
generating a string of true random number 0, 1 of a predetermined length by a preset method as a random seed;
acquiring data for several times from the random seed, and cascading the data acquired each time into a random string no shorter than the length of a plaintext;
according to the random string, generating a plaintext encryption bit identifier random string;
according to the plaintext encryption bit identifier random string, selecting more than one half of plaintext data for encryption; and
according to the position of the plaintext, arranging the encrypted data and unencrypted data to form a ciphertext.

2. The method of claim 1 wherein when data is acquired from the random seed for several times, the starting position of each data acquired and the acquisition length are random.

3. The method of claim 1 wherein the step of cascading comprises:
determining whether the length of the random string is greater than the length of the plaintext; if so, acquiring data from the random string for several times to generate a new random string no shorter than of the length of the plaintext.

4. The method of claim 1 wherein the step of generating a plaintext encryption bit identifier random string according to the random string comprises:
when the length of the random string is equal to the length of the plaintext, determining whether the number of 1 in the random string is greater than one half of the data bits of the plaintext; if so, selecting the random string as the plaintext encryption bit identifier random string; if not, conducting logical negation operation on the random string, and using the random string after logical negation operation as the plaintext encryption bit identifier random string;
when the length of the random string is greater than the length of the plaintext, acquiring data from the random starting position of the random string to form a new random string of the same length as the plaintext; determining whether the number of 1 in the new random string is greater than one half of the data bits of the plaintext; if so, selecting the new random string as the plaintext encryption bit identifier random string; if not, conducting logical negation operation on the new random string, and using the new random string after logical negation operation as the plaintext encryption bit identifier random string.

5. The method of claim 1 wherein the step of generating a plaintext encryption bit identifier random string according to the random string comprises:
generating a message digest value of the plaintext encryption bit identifier random string by the message digest operation; and
determining whether the message digest value is the same as the message digest value of the previously stored plaintext encryption bit identifier random string; if so, re-generating the plaintext encryption bit identifier random string; otherwise outputting and storing the plaintext encryption bit identifier random string, and meanwhile storing its message digest value.

6. The method of claim 1 wherein according to the plaintext encryption bit identifier random string, the step of selecting comprises:
starting from the first bit of data, arranging the plaintext encryption bit identifier random string and plaintext data correspondingly bit by bit in parallel; and
selecting the position of plaintext data corresponding to 1 in the plaintext encryption bit identifier random string as the encrypted data.

7. A selective data encryption apparatus comprising:
a true random number generation module for generating and storing by the preset method true random numbers and a string of true random numbers 0, 1 of a predetermined length as a random seed;
an encryption bit identifier random string generation module for acquiring data for several times from random seed generated by the true random number generation module, cascading the data acquired each time into a random string no shorter than the length of a plaintext, and according to the random string, generating a plaintext encryption bit identifier random string;
a plaintext data selectivity encryption module for randomly selecting more than one half of the plaintext data for encryption according to the plaintext encryption bit identifier random string generated by the encryption bit identifier random string generation module; and
a ciphertext formation module for arranging the data encrypted by the plaintext data selectivity encryption module and the unencrypted data according to their positions in the plaintext to form a ciphertext.

8. The apparatus of claim 7 wherein the apparatus also comprises:
an encryption bit identifier random string message digest value storage module for storing the message digest value of encryption bit identifier random string;
an encryption bit identifier random string message digest value generation module for generating by the message digest value operation a message digest value of the plaintext encryption bit identifier random string generated by the encryption bit identifier random string generation module, and returning the message digest value to the encryption bit identifier random string message digest value storage module; and
an encryption bit identifier random string verification module for comparing message digest value of the plaintext encryption bit identifier random string generated by the encryption bit identifier random string generation module and the message digest value in the encryption bit identifier random string message digest value storage module, and outputting the comparison result to the encryption bit identifier random string generation module.

9. A selective data decryption method comprising:
acquiring data from a random seed, and regenerating a plaintext encryption bit identifier random string corresponding to the encrypted plaintext;
extracting the encrypted data from the ciphertext and decrypting the encrypted data according to the plaintext encryption bit identifier random string; and
arranging the decrypted data and unencrypted data according to their positions in the ciphertext to form a plaintext.

10. The method of claim 9 wherein the step of acquiring is carried out in an encryption bit identifier random string restructuring module.

11. The method of claim 9 wherein the steps of extracting and decrypting are carried out in an encrypted data extraction and decryption module.

12. The method of claim 9 wherein the step of arranging is carried out in a plaintext restoration module.
